(19) United States
(12) Patent Application Publication
(10) Pub. No.: US 2024/0282993 A1
(43) Pub. Date: Aug. 22, 2024

(54) PRODUCTION SYSTEM FOR AUTOMATICALLY STACKING DIFFERENT COMPONENTS OF AN ELECTROCHEMICAL SYSTEM

(71) Applicants: Reinz-Dichtungs-GmbH, Neu-Ulm (DE); Robert Bosch GmbH, Stuttgart (DE)

(72) Inventors: Rainer GLUECK, Tormerdingen (DE); Felix SENF, Ulm (DE); Jochen BRENNER, Elchingen (DE); Eberhard MAIER, Koengen (DE); Andreas RETTICH, Herrenberg-Kuppingen (DE); Dirk VAHLE, Eberdingen (DE); Manfred MAERZ, Eberdingen (DE); Martin GERLACH, Strullendorf (DE)

(21) Appl. No.: 18/444,271

(22) Filed: Feb. 16, 2024

(30) Foreign Application Priority Data
Feb. 20, 2023 (DE) 20 2023 100 803.8

(51) Int. Cl. H01M 8/1004; H01M 4/86

(52) U.S. Cl. CPC H01M 8/1004; H01M 4/8631; H01M 2004/8694

(57) ABSTRACT

The present disclosure relates to a production system for producing at least one electrochemical system that comprises a stack consisting of a plurality of different components which are stacked one above the other along a stacking axis of the stack, with a height dimension of each component extending along the stacking axis where the production system allows the target height of the stack to be achieved in spite of the height tolerances of the different components.

### CROSS-REFERENCE TO RELATED APPLICATION

The present application claims priority to German Utility Model Application No. 20 2023 100 803.8, entitled “PRODUCTION SYSTEM FOR AUTOMATICALLY STACKING DIFFERENT COMPONENTS OF AN ELECTROCHEMICAL SYSTEM”, and filed Feb. 20, 2023. The entire contents of the above-listed application is hereby incorporated by reference for all purposes.

### TECHNICAL FIELD

The present disclosure relates to a production system for producing at least one electrochemical system that comprises a stack consisting of a plurality of different components which are stacked one above the other along a stacking axis of the stack, with a height dimension of each component extending along the stacking axis.

### BACKGROUND AND SUMMARY

Such electrochemical systems having a stacked configuration are known in the prior art, for example in connection with fuel cells. By way of example, reference is made to DE 20 2018 105 617 U1, and in particular to FIG. 1 therein.

The stack of such a system comprises a large number of individual layers or a large number of stacked individual components. By way of example, several hundred components may be stacked one above the other, for example 400 components or more. These components each have tolerances, in particular with regard to the respective height dimension thereof. This means that the height of a stack produced from these components is also subject to tolerance. Even if all the individual components have a height within a permissible tolerance range, the tolerances of these components may add up such that the stack produced therefrom no longer has a permissible height overall, i.e. the height thereof is outside a permissible tolerance range.

As described below on the basis of an example, this often leads to the situation where stacks that have already been produced and additionally tensioned must subsequently be unstacked again or rearranged in order to remain within a permissible tolerance range. This incurs additional costs and lengthens the production time. Components may also be damaged in the process.

One object of the present disclosure is therefore that of facilitating production of electrochemical systems that comprise a stack consisting of a plurality of different components, while reliably achieving a target height.

This object is achieved by the subject matter as described herein.

A production system for producing at least one electrochemical system is therefore proposed, wherein the electrochemical system comprises a stack consisting of a plurality of different components which are stacked one above the other (for example alternately) along a stacking axis of the stack, with a height dimension of each component extending along the stacking axis.

The production system is designed:
to determine height values for a large number of components and to store said height values in a machine-readable manner;
to automatically read out height values of at least selected components; and
to automatically produce a stack from a number of these components, taking into account the height values read out for these, namely such that a target height of the stack is achieved.

As will also be demonstrated herein, the production system may comprise multiple system components, such as multiple manufacturing lines or manufacturing stations. The production system may optionally comprise transport devices for transporting the parts manufactured on one respective manufacturing line or at one respective manufacturing station to another manufacturing station or manufacturing line.

By way of example, one manufacturing station or manufacturing line may be provided for at least a first component and one manufacturing station or manufacturing line may be provided for at least a second component. These two components may be transported (optionally by a transport device comprised by the production system) to a further manufacturing station or manufacturing line, at which they are stacked one above the other in order to produce the stack.

The production system may be fully or partially automated. It may be designed to execute at least the aforementioned steps b) and c) fully automatically (the steps also being referred to herein as measures). According to one development, step a) may also be (for example fully) automatically executed for at least one type of stacked component. The individual steps a), b) and c) may be executed in (or at) different manufacturing stations or manufacturing lines, or in any combination in at least one common manufacturing station or manufacturing line (for example a combination of steps b) and c)). In general, steps a) to c) may be executed separately in time and/or space, it being possible for the separation in time to be several hours or days (for example if the components are temporarily stored prior to being installed in the stack). The separation in space may be several kilometers, for example if the steps are carried out in different companies or at different manufacturing sites.

In the case of step a), the height values may, for example, be measured by means of a measuring device of the production system. At least selected components may be supplied (such as automatically) to said measuring device in order then to be measured (such as automatically).

The machine-readable storage may likewise take place automatically, for example by automatically applying and/or encoding information carriers (explained below) and/or by automatically saving the height values in a memory device.

In the context of step b), the automatic reading-out may comprise, for example, automatically detecting an information carrier (explained below) and/or a code that is linked to the height value of the component. This may comprise, for example, an optical detection (for example by a camera or scanner) or an electromagnetic detection, for example if the information carrier comprises an RFID chip.

In the context of step c), a stack may be produced, for example fully automatically, from a number of components, taking into account the height values read out for these, until the target height of the stack is achieved. This may comprise an automatic stacking of the components one above the other, for example through automated selection, automated sorting, automated gripping or some other type of automated handling. Step c) may be executed by means of an automated stacking device, for example a stacking machine. The stacking device may for example comprise a handling robot, for example an articulated-arm industrial robot.

The height values that are read out may be taken into account such that, on the basis thereof, for example, a stacking order of the components is specified and/or compensating elements or dummy cells are selected as additional stack components. Further examples will be explained below.

The target height of the stack may be subject to tolerance and/or may be encompassed by a tolerance range that includes a plurality of permissible target height values. In other words, it is possible that not just one permissible target height value is specified, but rather a certain range of values encompassing multiple permissible target height values. The target height may be achieved if any of these permissible target height values is achieved.

When a stack is mentioned herein, this may refer to a finished state of the stack produced, such as after any tensioning thereof (see below). However, the stack may also be in a not yet fully tensioned state; instead, the term sub-stack may be used to denote, for example, the sequence of all the components to be stacked one above the other or at least all the components to be alternately stacked. A group of components consisting of alternately stacked bipolar plates and electrochemical cells is also referred to as a core stack. The core stack and the sub-stack are thus special examples of a stack in the context of this disclosure.

Correspondingly, the target height may refer to or be applicable to a stack (such as in the present case in the form of a sub-stack of the aforementioned type) which comprises a predetermined number of components stacked one above the other and, for example, alternately. For instance, this stack may not yet be tensioned and/or may not include height-compensating elements and/or dummy cells. However, it may also be provided that the target height refers to a stack that has been produced in full and may be tensioned, for example also including height-compensating elements and/or dummy cells.

The method may in general comprise determining, and updating, continuously, and for example after each component, a current actual height of the stack (such as in the present case in the form of a sub-stack of the aforementioned type). To this end, the height values read out for the components stacked thus far can be summed. Based thereon (or in general on the basis of a summing of the height values of the components that have been stacked and/or in advance on the basis of a summing of the height values of components that are yet to be stacked), the actual height of the finished stack can be calculated. As an alternative or in addition, the actual height of the sub-stack produced thus far may be measured, and more specifically checked, which in turn may take place in an automated manner and/or within the same stacking device by which the components are stacked.

The proposed production system makes it possible to obtain knowledge about the height of a ful (e.g. also tensioned) stack or sub-stack even before the stack is produced and/or in a flexible manner during production thereof, but at the latest after it has been produced. This knowledge can be used to flexibly adapt the stacking process and thus ensure compliance with the target height. As an alternative or in addition, once stacking has taken place, for instance of alternately stacked components, additional height-influencing components may be selected in a targeted manner in order to achieve the target height. Examples of such additional components are compensating elements or dummy cells, which will be explained below.

In this way, forward-looking stacking can take place, by means of which it can be ensured from the outset that the target height will be achieved. For instance, it is possible to make a correction during stacking and/or to adjust the stacking if the height values of the components stacked one above the other thus far indicate an expected deviation from the target height (determined, for example, on the basis of an extrapolation of the current actual height value, taking into account the number of components to be stacked that are still missing).

It is advantageous, for example, that, in the solution presented here, the current (actual) height values of at least selected components, which are subject to tolerance, can be determined as the corresponding height values thereof and taken into account. This differs from existing methods, in which only nominal height values of the stacked components are used as a basis, and an actual stack height affected by the tolerances thereof can only be measured after a stack has been produced. At this stage, corrections to the already produced and possibly tensioned stack are no longer possible or require at least partial unstacking and de facto re-stacking. Such a time-consuming, iterative procedure can be prevented by estimating an actual height of the stack on the basis of the component height values that have been read out, which is made possible according to the present disclosure.

According to one development, the production system is designed to determine the respective height value of at least selected components individually, such as by measuring the height value. For example, for all components of at least one type, the respective height value may be determined individually. For components of at least one other type, a height value may be determined according to one of the following alternative variants. Determining height values individually may be a precise way to determine height values, by means of which an actual stack height of the stack produced or to be produced can accordingly be precisely determined.

The individual determination of height values may comprise, for example:
individually measuring the height value (e.g. performing an individual measurement for each component); and/or
individually calculating the height value (e.g. performing an individual calculation for each component), may be a function of how the component is individually assembled from pre-products.

The pre-products may also be referred to as sub-components or partial components. The component may be assembled therefrom, such as by the production system. If height values of the pre-products are known, these can be summed to obtain a height value of the component assembled therefrom. For example, the pre-products may be single-layer separator plates, which are assembled to form a bipolar plate.

According to another embodiment, the production system is designed to determine, for at least one type of component, a representative height value that is stored for a plurality of components of this type. This may comprise determining a height value on the basis of samples, namely for one or more components of a type. The height value obtained (or a height value which is determined on the basis of the sample, and which is, for example, an average height value) can then be stored as applicable to a further plurality of components of the same type, the height values of which will not be measured. Determining such a representative height value is an efficient way to precisely estimate the component height values and an actual stack height by means of a reduced number of individual component measurements.

Representative height values of the manufactured individual plates are determined, for example, when configuring the manufacturing line or at the start of manufacture following a reconfiguration of the manufacturing line. Representative height values of the welded bipolar plates are determined, for example, following changes to the welding device. Representative height values of the coated bipolar plates are determined, for example, following changes to the coating system. For example, after each reconfiguration of the manufacturing line, a representative plate height value is determined for the plates manufactured thereby, without each of the plates thus produced being measured separately to determine an individual height value.

According to another aspect, the production system is designed to execute at least one of the following measures in order to store the height values in a machine-readable manner:
I. Saving in an internal memory device of the production system;
II. Saving in an external memory device (for example a cloud memory device and/or a memory device positioned outside of the production system, which can be accessed via wireless or wired data connections), the production system being designed to access the external memory device for the purpose of reading out the height values;
III. Encoding a height value in a machine-readable code that is applied to at least one of the components;
IV. Encoding a link to a storage location of a height value in a machine-readable code that is applied to at least one of the components.

For instance, in the context of measures I. and II., the production system may be designed to identify a component individually and to assign the height value of said component to an identifier (for example in the form of a data element or data entry) associated with the component within the memory device. Identification may take place through machine reading of an information carrier applied to the component. This information carrier may be the same information carrier to which, according to embodiments disclosed here, the height value is also linked. Alternatively, it may be an additional information carrier, which may be used exclusively to identify the component and is not used for linking it to the height value. For instance, the information carrier may comprise a code according to any variant disclosed herein.

In the context of measure III., the height value may for example be encoded as a machine-readable (but possibly encrypted or converted) value in the code and thus stored.

In the context of measure IV., the link may for example be encoded in machine-readable (but possibly encrypted or converted) form in the code and thus stored. The storage location may be encompassed by an internal memory device of the production system or by an external memory device.

Any code disclosed herein may comprise an inscription and/or a pattern. The pattern may in turn be configured as a barcode, a 2D code, such as a data matrix code or QR code, a color pattern, a stamped pattern and/or an embossed pattern. The information carrier may be, for example, a removable component (for example a sticker) or a surface area of the component, the component or the surface area featuring the code (for example, since they are printed or embossed with a corresponding pattern). As an alternative or in addition, the code may be stored in a chip, which serves as an information carrier and may be an RFID chip.

One development provides that at least measures a) and c) are executed in different devices and/or at different manufacturing stations (or even in different manufacturing lines) of the production system. These devices and/or manufacturing stations may be separate in space and may optionally be located in different companies or factories. By way of example, a subcontractor that manufactures the components may execute measure a), whereas a manufacturer of the electrochemical system may execute measure c) and optionally also b). This makes it possible for measures a)-c) to be efficiently distributed along a manufacturing chain, and may be at positions along this manufacturing chain at which the measures can easily be executed.

The production system may be designed to produce a plurality of stacks or even complete electrochemical systems comprising such stacks. For instance, the production system may be designed for serial production of stacks or complete electrochemical systems, for example comprising batches of several times 50 or more than 500 per day.

By way of example, according to another embodiment, measure a) is executed for a large number of components, from which, in principle, multiple stacks can be produced in order to produce a plurality of electrochemical systems. This shows that, according to some embodiments, when producing stacks, components for a specific stack can be selected individually in step c) as required, on the basis of their height values, in order to achieve the target height. Components that have not been selected can be used to produce further stacks.

Alternatively, it is possible, but not mandatory, to specify in advance all the components that are to be installed in a stack and to select, for example, only compensating elements or dummy cells on the basis of their height values, but not the components themselves that are to be installed.

In one embodiment, the production system is designed to determine a required number of height-compensating elements that are to be arranged in the stack in order to achieve the target height, it being possible for said number to be zero, one, or more than one. The height-compensating elements may have an identical height, so that the number thereof defines a corresponding multiple of this height as the total height of a group of compensating elements.

In addition or as an alternative, the production system is designed to determine a required height dimension of at least one height-compensating element that is to be arranged in the stack in order to achieve the target height of the stack.

Both when flexibly determining the number of height-compensating elements and when determining the height dimension thereof, the number or the height dimension can be calculated on the basis of a current actual height of the sub-stack produced thus far. The actual height of the stack may be obtained, for example, by summing the height values of the components stacked one above the other thus far. The actual height of the stack may be calculated once the stack of components is complete and/or once all the components of the core stack, which for example are stacked alternately, have been stacked one above the other. The required height dimension and/or the number of height-compensating elements may be determined on the basis of a difference between the actual height and the target height, and may correspond to and compensate for this difference.

To sum up, both the required number of height-compensating elements and also any height dimension of at least one height-compensating element may be determined by taking into account the read-out height values of the components.

By means of these variants, a height-compensating element with an exact fit and/or a suitable number of height-compensating elements can be flexibly selected, and may be selected individually for each stack, so that the target height is reliably achieved.

The height-compensating elements may generally be electrochemically inactive elements. They may be flat or uneven plate-shaped components, the base area of which for example substantially corresponds to a base area of the stack (for example differs therefrom by no more than 45%). The height-compensating elements may have, for example, a maximum height of 3 cm, a maximum height of 1.5 cm, of 0.8 cm, or even a maximum height of 0.4 cm.

In addition or as an alternative, the production system may be designed to determine a required number of electrochemically inactive dummy cells that are to be arranged in the stack in order to achieve a target height of the stack, it being possible for said number to be zero, one, or more than one. The electrochemically inactive dummy cells may have similar dimensions to and may be the same height as electrochemically active cells.

The electrochemically inactive dummy cells may, for example, be different from other components contained in the stack and from the electrochemically active cells. For instance, a large number of electrochemically active cells may be stacked one above the other in the stack (for example, alternating with at least one other type of component), whereas the dummy cells may be stacked on a core stack with multiple active cells. By way of example, a dummy cell may have no membrane electrode assemblies (MEAs) or gas diffusion layers, but may have all the other constituent parts of electrochemically active cells in the stack.

Both the height-compensating elements and the dummy cells may have media through-openings which enable the passage of media in the stacking direction, or they may have such media through-openings only for some of the media, or they may have no media through-openings, for example depending on their position in the electrochemical system.

The number of dummy cells can be determined analogously to any variant disclosed herein for determining the number of height-compensating elements, e.g. such as by taking into account the read-out height values of components of the stack.

According to known prior art approaches, the production system may be designed to tension the stack once all the components, including any height-compensating elements and/or dummy cells, have been stacked one above the other. For example, straps (such as metal straps) or other tensioning elements that at least partially surround the stack or bear against it can be used for this purpose. These can be tightened against and around the stack and thus tension the components comprised by the latter. In addition or as an alternative, tensioning forces may be generated by means of bolts, screws and/or springs.

One development provides that the production system is designed to tension the stack only after any height-compensating elements and/or any dummy cells have been arranged therein. For instance, the stack may then be tensioned for the first time. Furthermore, this may be the only tensioning of the stack, for example before the stack leaves the production system or, in other words, before production of the stack by the production system is finished. In contrast to the prior art, it may therefore not be provided to tension the stack and release the tension again iteratively multiple times in order to vary height-compensating elements and/or dummy cells until a target height has been achieved. Instead, in the present case, it is ensured that the target height is reliably achieved so that, even without an optional final measurement of the actual height of the stack, the latter can be tensioned directly, once and for all. This reduces the time required to produce the stack and thus accordingly reduces the occupancy of any stacking device of the production system. Notwithstanding this, with the present production system, it is also possible for the stack to be tensioned and for the tension to be released again multiple times, but not for the purpose of changing the composition of the stack.

One development provides that the production system is designed to select a plurality of components, taking into account the (read-out) height values thereof, in order to produce the stack. For instance, these components may be selected from a large number of components which, in principle, can be used to produce a plurality of stacks for a corresponding plurality of electrochemical systems. By way of example, a corresponding large number of components can be made available to a stacking device, whereupon the stacking device selects, in advance or during the stacking process, at least individual components in order to reliably achieve the target height of a finished stack.

If the production system ascertains, for example, that an optionally determined extrapolated final (and/or expected) height of a finished stack does not correspond to the target height, this can be flexibly counteracted by selecting components in a targeted manner and taking their height values into account. This makes it possible for components to be selected in a forward-looking manner and for the stack to be produced flexibly, by which the target height can be reliably achieved.

According to one development, the components are selected in order to produce a common portion of the stack to be produced, e.g. a sub-stack, namely such that a target height of said common portion is achieved, wherein the common portion may comprise at least one pair of components, a large number of which are stacked alternately in a higher-level (core) stack or, in other words, within the stack. In this case, therefore, the achievement of a target height of the common portion (and not just of the complete stack) can therefore already be monitored by the production system and can be ensured by a suitable choice of components.

Also in this case, an extrapolated height of the common portion can be calculated, for example, on the basis of the components selected for said portion thus far, and at least one further component can be selected on the basis of its height value such that the height then extrapolated corresponds to the target height. In addition or as an alternative, a difference between an actual height of components selected for the common portion thus far and a target height of said common portion can be determined, and at least one further component can then be selected on the basis of its height value in order to achieve the target height.

If the common portion comprises just one pair of components, a large number of which are stacked alternately in a higher-level core stack or, in other words, within the stack, the achievement of the respective target height may be ensured on a pair-by-pair basis. One component of the pair, which for example has a below-average height value, can be combined with a further component which has been selected in a targeted manner and which has a correspondingly above-average height value, so that the respective height value deviations thereof compensate for each other. Such compensating effects can also be achieved for other common portions, for example comprising multiple pairs of components, a large number of which are stacked alternately in a higher-level core stack or, in other words, within the stack.

According to one development, the production system is designed to determine an actual height value of the at least partially produced stack, e.g. of a sub-stack, such as during production of the stack, and may determine this continuously. This may comprise continuously updating the actual height value, for example after each additional component is arranged in the stack and/or after each additional component is selected for the stack.

In addition or as an alternative, the production system may be designed to determine an expected extrapolated height value of the stack, and for example of the finished stack. The expected extrapolated height value may exist after the stack has been compressed. For example, the expected extrapolated height values may be calculated on the basis of the (summed) height values of the components that have been stacked one above the other thus far, and on the basis of the number of remaining components to be stacked one above the other. For example, an experimentally determined expected height compression resulting from the tensioning can be used to optionally determine a height value after tensioning.

The expected extrapolated height value can be used, for example, to estimate whether the target height is realistically achievable if a current component batch continues to be stacked, or whether, for example, another component batch has to be requested. In general, the expected extrapolated height value can also be used to determine which components have to be selected in order still to achieve the target height (see below).

It may therefore be provided that the actual height value and/or the expected extrapolated height value is determined on the basis of a summing of the height values of the components that have been stacked one above the other thus far.

The actual height value and/or the expected extrapolated height value may be used to select components for producing the stack. If, for example, the actual height value and/or the expected extrapolated height value are outside a permissible range, at least one component may be selected such that the actual height value and/or the expected extrapolated height value reduces the difference in relation to the permissible range. By way of example, components which are oversized or undersized in terms of their height value may be selected in order to compensate for deviations from the permissible range.

According to one variant, the electrochemical system is a fuel cell system, and the stack comprises at least one of the following types of components:
bipolar plates, wherein different media are guided for example on both surfaces of the bipolar plates, and/or wherein the bipolar plates are each formed of two separator plates, wherein the separator plates are, for example, metal plates, for example manufactured by stamping or embossing;
unipolar plates, comprising one or two separator plates, such as at a lowermost and/or uppermost position in a sub-stack that comprises a plurality of alternately stacked bipolar plates and cells. By way of example, the unipolar plates may enclose between them the alternately stacked bipolar plates and cells, all the alternately stacked bipolar plates and cells, e.g. the core stack, and may occupy a lowermost and uppermost position in the resulting sub-stack;
endplate assemblies, which for example include or accommodate channels for supplying and/or discharging reactants, reaction products and/or coolants, and/or on which straps used for tensioning rest or are fastened;
membrane electrode assemblies (MEAs);
seals;
gas diffusion layers, for example each comprising an electrically conductive carbon fleece;
electrochemical cells, each comprising an MEA and at least one gas diffusion layer, such as one gas diffusion layer on each side of an MEA.

Any separator plate mentioned herein may comprise a metal layer, for example comprising steel, such as stainless steel, aluminum, titanium or electrically conductive composite materials, such as graphite composite materials. In addition or as an alternative, on any separator plate mentioned herein, conductive coatings may be present in an electrochemically active region, said conductive coatings comprising for example graphite, graphene, chromium, niobium, tantalum, or chromium-nickel alloys. Conventional sheet thicknesses for producing a separator plate may be between 50 and 200 micrometers, between 60 and 150 micrometers. In the case of composite separator plates, the maximum thicknesses are in the range from 150 to 700 micrometers. A bipolar plate may be produced by joining two separator plates and may have a correspondingly increased total height.

As is generally known, the separator plates and bipolar plates produced therefrom may be designed to separate electrochemical cells from each other and to supply these with media.

According to another variant, the electrochemical system is an electrolyzer and the stack comprises at least one of the following types of components:
separator plates, such as between electrochemical cells of the system and/or between an electrochemical cell and an endplate assembly, wherein the separator plates may be, for example, metal plates, for example manufactured by stamping or embossing;
electrochemical cells, each comprising at least one proton-exchange membrane and optionally one or more gas diffusion layers and/or one or more transport layers;
endplate assemblies, which for example include or accommodate channels for supplying and/or discharging reactants and/or reaction products, and/or on which tensioning elements used for tensioning rest or are passed therethrough;
proton-exchange membranes;
frame elements;
sealing elements;
gas diffusion layers, for example each comprising an electrically conductive carbon fleece;
transport layers, also referred to as porous transport layers (PTLs).

According to another variant, the electrochemical system is an electrochemical compressor or a redox flow battery.

In one embodiment, the stack comprises bipolar plates or single-layer separator plates, such as e.g. unipolar plates, as components, the height values of these components referring to at least one of the following states:
height (thickness) of the starting material used to produce the individual plates for producing the bipolar plates;
height after the individual plates have been embossed and/or cut to size to produce the bipolar plates or after the separator plates have been embossed and/or cut to size;
height after the individual plates have been joined to produce the bipolar plates;
height after the bipolar plates or separator plates have been coated, for example with a conductive coating of the type explained above;
height after a seal has been applied to the bipolar plates or separator plates.

In the case of the second state, production-related influences and influences of selected tools may be included in the height value and may thus be taken into account.

In the case of the third state, influences of the joining process may be included in the height value and may thus be taken into account.

In the case of the fourth state, influences of the coating process and/or of a material used for the coating process may be included in the height value and may thus be taken into account.

In the case of the fifth state, tolerances of the seal and/or influences of the seal installation and/or application process may be included in the height value and may thus be taken into account.

In each of the states indicated, the validity of a height value respectively determined for the components can be increased and thus the reliability of achieving a target height can be improved.

According to one development, the stack comprises MEAs and gas diffusion layers as components (and, for example, electrochemical cells formed therefrom), the height values of these components referring to at least one of the following states:
height after the gas diffusion layers have been cut to size;
height of the MEA used;
height after one of the MEAs and one or two gas diffusion layers have been joined (and thus for example an electrochemical cell has been produced), prior to these being arranged in the joined state in the stack to be produced.

In the case of the first state, batch influences of a material from which the gas diffusion layer is made may be included in the height value and may thus be taken into account.

In the case of the second state, batch influences of one or more materials from which the MEA is made may be included in the height value and may thus be taken into account.

In the case of the third state, both batch influences of at least one material from which the gas diffusion layer and/or the MEAs are made and influences of the respective manufacturing processes thereof may be included in the height value and may thus be taken into account.

In this way, the validity of a height value respectively determined for the components can be increased and thus the reliability of achieving a target height can be improved.

The present disclosure also relates to a method. The method can be carried out by means of a production system according to any of the aspects disclosed herein. All variants and developments that are disclosed in the context of the production system also apply to the method, such as in connection with features that are identical or similar to those of the production system.

The present disclosure relates to a method according to the following aspects:

Aspect 1: Method for producing at least one electrochemical system that comprises a stack consisting of a plurality of different components which are stacked one above the other along a stacking axis of the stack, with a height dimension of each component extending along the stacking axis,
wherein the method comprises:
determining height values for a large number of components and storing said height values in a machine-readable manner;
automatically reading out height values of at least selected components; and
automatically producing a stack from a number of these components, taking into account the height values read out for these, namely such that a target height of the stack is achieved.

Aspect 2: Method according to aspect 1,
which further comprises:
determining the respective height value of at least selected components individually.

Aspect 3: Method according to aspect 2,
wherein the individual determination comprises:
individually measuring the height value; and/or
individually calculating the height value, as a function of how the component is individually assembled from pre-products.

Aspect 4: Method according to any one of aspects 1 to 3,
which further comprises:
determining, for at least one type of component, a representative height value that is stored for a plurality of components of this type.

Aspect 5: Method according to any one of aspects 1 to 4,
wherein storing in a machine-readable manner comprises at least one of the following measures:
saving in an internal memory device of the production system;
saving in an external memory device, the production system being designed to access the external memory device for the purpose of reading out the height values;
encoding a height value in a machine-readable code that is applied to at least one of the components;
encoding a link to a storage location of a height value in a machine-readable code that is applied to at least one of the components.

Aspect 6: Method according to any one of aspects 1 to 5,
wherein at least measures a) and c) are executed in different devices and/or at different manufacturing stations of a production system for producing the electrochemical system.

Aspect 7: Method according to any one of aspects 1 to 6,
wherein measure a) is executed for a large number of components, from which, in principle, multiple stacks can be produced in order to produce a plurality of electrochemical systems.

Aspect 8: Method according to any one of aspects 1 to 7,
which further comprises:
determining a required number of height-compensating elements that are to be arranged in the stack in order to achieve the target height, it being possible for said number to be zero, one, or more than one.

Aspect 9: Method according to any one of aspects 1 to 8,
which further comprises:
determining a required height dimension of at least one height-compensating element that is to be arranged in the stack in order to achieve the target height of the stack.

Aspect 10: Method according to any one of aspects 1 to 9, which further comprises:
determining a required number of electrochemically inactive dummy cells that are to be arranged in the stack in order to achieve a target height of the stack, it being possible for said number to be zero, one, or more than one.

Aspect 11: Method according to any one of aspects 8 or 9 and/or according to aspect 10, which further comprises:
tensioning the stack only after any height-compensating elements according to any one of aspects 8 or 9 have been arranged in the stack and/or after any dummy cells according to aspect 10 have been arranged in the stack.

Aspect 12: Method according to any one of aspects 1 to 11,
which further comprises:
selecting a plurality of components, taking into account the height values thereof, in order to produce the stack.

Aspect 13: Method according to aspect 12,
wherein the components are selected in order to produce a common portion of the stack to be produced, namely such that a target height of said common portion is achieved, such as wherein the common portion comprises at least one pair of components, a large number of which are stacked alternately within the stack.

Aspect 14: Method according to any one of aspects 1 to 13,
which further comprises:
determining an actual height value of the at least partially produced stack while the stack is being produced, and/or an expected extrapolated height value of the finished stack, wherein the expected extrapolated height value may exist after the stack has been compressed.

Aspect 15: Method according to aspect 14,
wherein the actual height value and/or the expected extrapolated height value is or are determined on the basis of a summing of the height values of the components stacked one above the other thus far.

Aspect 16: Method according to aspect 12 and any one of aspects 14 and 15;
wherein the components are selected by taking into account the actual height value and/or the expected extrapolated height value.

Aspect 17: Method according to any one of aspects 1 to 16,
wherein the electrochemical system is a fuel cell system and the stack comprises at least one of the following types of components:
bipolar plates, such as those formed of two separator plates;
unipolar plates, comprising one or two separator plates, such as those at a lowermost and/or uppermost position in a sub-stack comprising a plurality of alternately stacked bipolar plates and cells;
endplate assemblies;
membrane electrode assemblies (MEAs);
seals;
gas diffusion layers;
electrochemical cells, each comprising an MEA and at least one gas diffusion layer.

Aspect 18: Method according to any one of aspects 1 to 16,
wherein the electrochemical system is an electrolyzer and the stack comprises at least one of the following types of components:
separator plates, such as those between electrochemical cells of the system and/or between an electrochemical cell and an endplate assembly;
electrochemical cells, each comprising at least one proton-exchange membrane and optionally one or more gas diffusion layers and/or one or more transport layers;
endplate assemblies;
proton-exchange membranes;
frame elements;
sealing elements;
gas diffusion layers;
transport layers.

Aspect 19: Method according to any one of aspects 1 to 16, wherein the electrochemical system is an electrochemical compressor or a redox flow battery.

Aspect 20: Method according to any one of the preceding aspects 1 to 19,
wherein the stack comprises bipolar plates or single-layer separator plates, such as e.g. unipolar plates, as components, the height values of these components referring to at least one of the following states:
height (thickness) of the starting material used to produce the individual plates for producing the bipolar plates;
height after the individual plates have been embossed and/or cut to size to produce the bipolar plates or after the separator plates have been embossed and/or cut to size;
height after the individual plates have been joined to produce the bipolar plates; height after the bipolar plates or separator plates have been coated;
height after a seal has been applied to the bipolar plates or separator plates.

Aspect 21: Method according to any one of the preceding aspects 1 to 20, wherein the stack comprises MEAs and gas diffusion layers as components, the height values of these components referring to at least one of the following states:
height after the gas diffusion layers have been cut to size;
height of the MEA used;
height after one of the MEAs and one or two gas diffusion layers have been joined, prior to these being arranged in the joined state in the stack to be produced.

Exemplary embodiments of the present disclosure will be explained below with reference to the accompanying schematic figures. The same reference signs may be used for the same or similar features across the figures.

### BRIEF DESCRIPTION OF THE FIGURES

FIG. 1 shows a fuel cell system that can be produced by a production system according to one embodiment of the present disclosure.

FIG. 2 shows a production system and a production process carried out by the production system, according to one example from the prior art.

FIG. 3 shows a production system and a method carried out by the production system, according to one embodiment of the present disclosure.

FIG. 3A shows an alternate variant of part of the production system from FIG. 3.

FIG. 3B shows another alternate variant of part of the production system from FIG. 3.

FIG. 4 shows a production system and a method carried out by the production system, according to another embodiment of the present disclosure.

### DETAILED DESCRIPTION

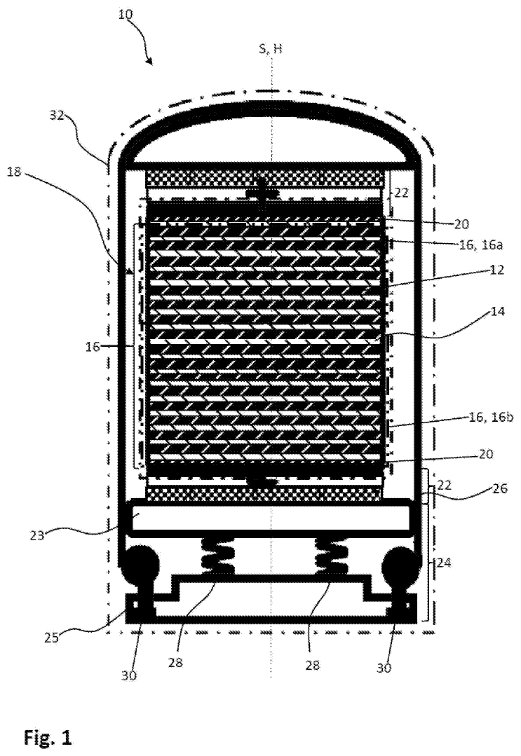

FIG. 1 shows a fuel cell system 10 in a sectional view. The section plane includes a stacking axis S, which will be explained below. The fuel cell system 10 can be produced by a production system according to one exemplary embodiment of the present disclosure and by a method disclosed herein. The fuel cell system 10 is an example of an electrochemical system.

The fuel cell system 10 comprises a plurality of components 12, 14 stacked alternately one on top of the other, or in other words one above the other. Only selected ones of the components 12, 14 are provided with a reference sign.

Stacking takes place along a stacking axis S, which for example corresponds to a virtual spatial axis. The components 12, 14 are different, namely on the one hand bipolar plates 12 and on the other hand electrochemical cells 14, as indicated by different types of hatching. The bipolar plates 12 are each assembled from separator plates (not shown separately). The electrochemical cells 14 each comprise an MEA (not shown separately) and gas diffusion layers applied to both sides of the latter. The electrochemical cells 14 are in each case separated from each other by a bipolar plate 12.

The alternately stacked bipolar plates 12 and electrochemical cells 14 form, for example, two sub-stacks 16a and 16b of a total stack 18 to be produced and tensioned, the two sub-stacks 16a and 16b here also jointly forming in turn a sub-stack 16.

This sub-stack 16 further comprises, at a lowermost and uppermost position, unipolar plates 20, which are indicated by identically sloping but twice as dense hatching as the bipolar plates. Said unipolar plates enclose between them the arrangement of alternately stacked bipolar plates 12 and electrochemical cells 14.

The stack 18 further comprises two endplate assemblies 22, which enclose between them the first sub-stack 16 and the unipolar plates 20 and are located opposite each other along the stacking axis S. Purely by way of example, the endplate assemblies 22 are of multi-part construction; they may comprise, for example, current collector plates, insulating plates and/or fluid supply plates.

Not shown are optional height-compensating elements and dummy cells, as will be explained in greater detail below. These may be positioned below the upper endplate assembly 22 and may be in contact with the upper endplate assembly 22.

The fuel cell system 10 also comprises a tensioning system 24. The latter interacts with at least one metal strap 26, which is passed along the upper endplate assemblies 22. It is also possible for a plurality of metal straps 26 to be provided, these being arranged perpendicular to the plane of the drawing in front of and/or behind the illustrated metal strap 26.

The actual tensioning system 24 comprises fastening bolts 30, which are bolted to a baseplate 25. The fastening bolts 30 are directly or indirectly connected to the at least one metal strap 26 in order to apply a tensile force to the metal strap 26.

The tensioning system 24 comprises schematically shown elastic elements 28, which may for example be embodied as metal springs. The elastic elements 28 extend between a pressure transfer plate 23 and the baseplate 25 and are supported against each of these. The elastic elements 28 can generate a tensioning force which acts counter to the tensile force of the metal strap 26 to securely hold the sub-stack 16 between the endplate assemblies 22. Finally, an optional housing 32 is shown, in which the fuel cell system 10 may be arranged.

A height axis H of the fuel cell system 10 and of the components comprised by the latter coincides with the stacking axis S. The height values of the components 12, 14, for example, thus also extend along the height axis H and refer to a thickness and/or material thickness of these components 12, 14.

After being tensioned, the fuel cell system 10 should have a permissible target height (e.g. target total height). The present disclosure makes it possible to estimate, in advance and/or flexibly during stacking, whether and/or by which measures this target height can be achieved.

The focus may be on achieving a target height of the stack 18, which includes both endplate assemblies 22, as a significant component of the target total height of the fuel cell system 10, and/or at least on achieving a target height of the sub-stack 16 (e.g. plus the lower endplate assembly 22 and/or at least one of the unipolar plates 20).

To increase the likelihood of the fuel cell system 10 achieving a permissible target total height after being tensioned, it does not matter to which of the aforementioned system portions (for example stack 18 or sub-stack 16) the target height under consideration refers. A corresponding increase in this likelihood can be achieved in all cases. However, the more components comprised by the system portion for which the achievement of the target height is being monitored and ensured in the manner disclosed here, the higher the likelihood may be that a target total height of the tensioned fuel cell system 10 will also be achieved.

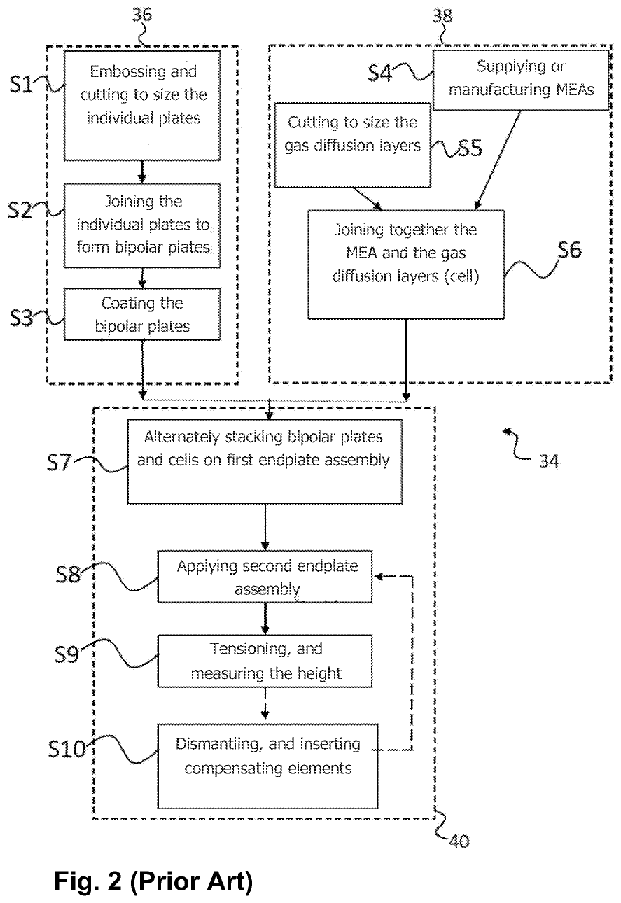

With reference to FIG. 2, first a production system 34 according to a conventional prior art approach will be explained, by which a fuel cell system 10 according to FIG. 1 can be produced.

As demonstrated below, this existing approach does not enable a comparable, forward-looking and/or flexible stacking to achieve a target height.

The production system 34 of FIG. 2 comprises a bipolar plate manufacturing line 36, a cell manufacturing line 38, and a stacking device 40 (also referred to as a stacking machine).

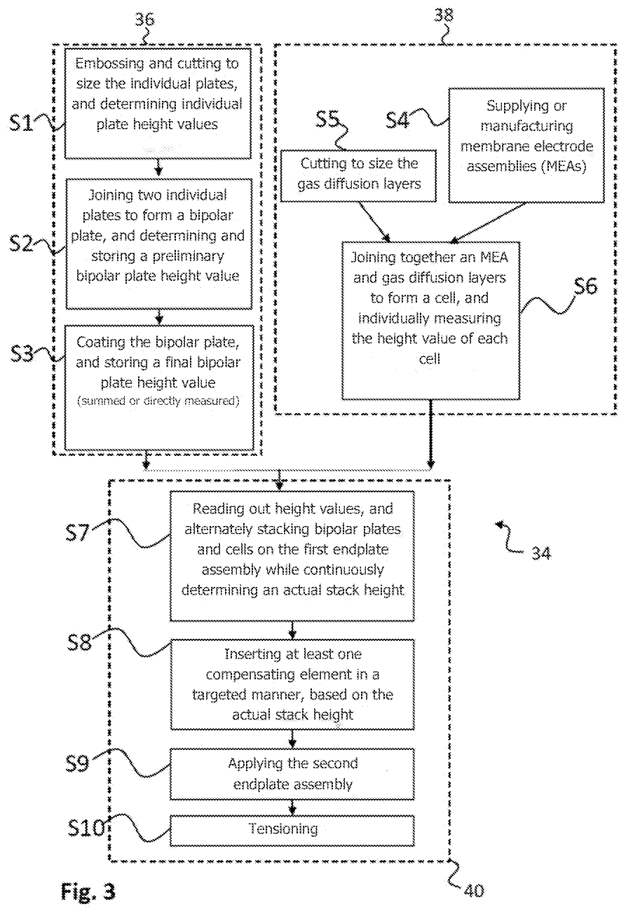

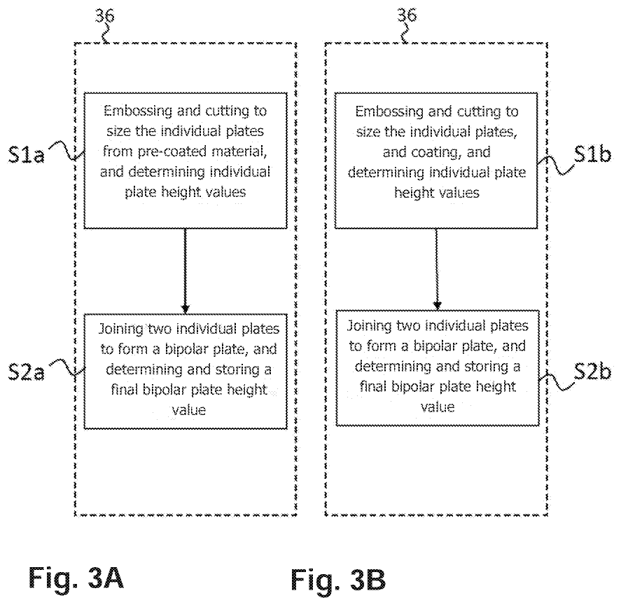

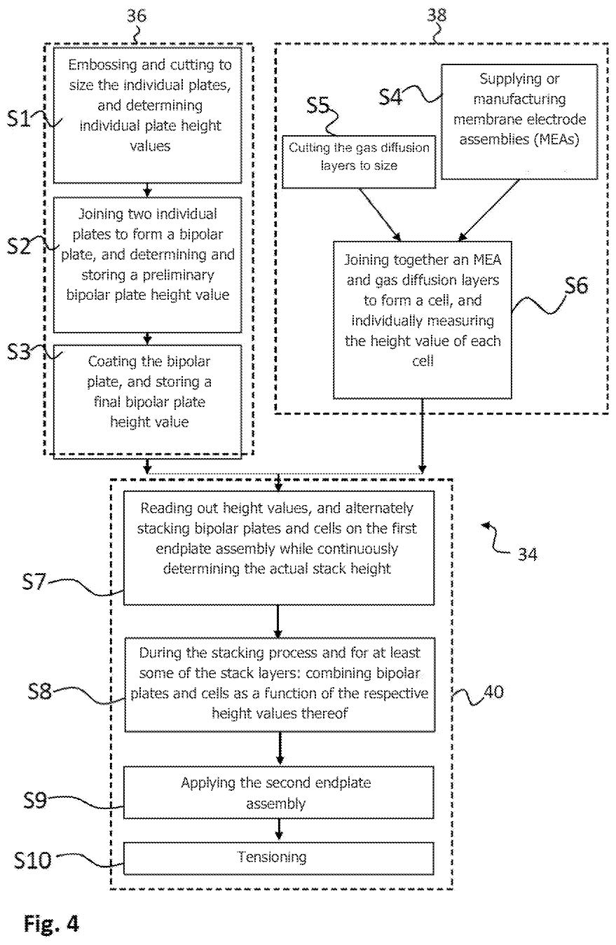

Manufacturing steps S1-S10, which are carried out within these manufacturing lines 36, 38 and the stacking device 40, will be explained below. The numbering of these manufacturing steps S1-S10 corresponds to a possible order in which these steps are carried out, without such an order being mandatory. The bipolar plate manufacturing line 36 and the cell manufacturing line 38 may be operated in parallel such that the manufacturing steps S1-S6 thereof are also in part carried out in parallel and/or in a temporally overlapping manner. The above-explained meaning of the numbering of manufacturing steps S1-S10 also applies to the additional FIGS. 3, 3a, 3b and 4. Said manufacturing steps also need not be exhaustive; the production method may include additional manufacturing steps, but these are not listed here.

Bipolar plates for alternate stacking by means of the stacking device 40 (see bipolar plates 12 in FIG. 1) are produced in the bipolar plate manufacturing line 36. The bipolar plates are assembled from individual plates (for example single-layer separator plates). In a first manufacturing step S1, these individual plates are cut out of a large-format sheet, for example, and are provided with a height profile by embossing. The sheet may for example be in the form of a roll (or coil) having a width adapted to the individual plates and may be unwound in portions. The sheet may be cut by stamping.

In a second manufacturing step S2, in each case two of these individual plates are joined, for example by welding, to form a bipolar plate. In a third manufacturing step S3, the bipolar plates are coated for example with an electrically conductive coating. The bipolar plates thus produced and coated are for example brought together and transported as a production batch to the stacking device 40.

Electrochemical cells, likewise for alternate stacking by means of the stacking device 40 (see electrochemical cells 14 in FIG. 1), are produced in the cell manufacturing line 38. The electrochemical cells each comprise an MEA, on which a gas diffusion layer may be arranged on both sides. The MEAs are therefore supplied and/or manufactured, for example cut to size, in a manufacturing step S4 within the cell manufacturing line 38. In a manufacturing step S5, the gas diffusion layers are individually cut out from a rolled-up strip of material, for example. A respective MEA may then be joined to two gas diffusion layers (step S6). The electrochemical cells thus produced are for example brought together and transported as a production batch to the stacking device 40.

The stacking device 40, which may for example comprise an industrial robot, alternately stacks the supplied bipolar plates and electrochemical cells on top of each other (step S7). These components are taken from a respective supply area. They are typically taken and stacked according to the order in which they were supplied (for example, the order thereof in a transport box). An endplate assembly 22 from FIG. 1 serves as a stacking platform or stacking base.

The tensioning system 24 may already be arranged below the endplate assembly 22 or may subsequently be arranged adjacent to an endplate assembly 22.

Once a predetermined number of bipolar plates and electrochemical cells have been alternately stacked, in a step S8 the second endplate assembly 22 from FIG. 1 is applied to the sub-stack produced thus far.

In a subsequent step S9, the stack, including the endplate assemblies, is tensioned and thereby compressed. An actual height of the tensioned stack and thus of the finished fuel cell system is then measured. This actual height is compared with a target height. If the difference between these heights is outside a permissible range, the fuel cell system is dismantled by releasing the tension and partially unstacking again. At least the uppermost endplate assembly may be removed in order, for example, to insert or replace a height-compensating element directly below it. This may take place if the actual height is below the target height.

Typically, the number of alternately stacked components and/or the target height of the fuel cell system is selected in such a way that it is unlikely that this target height will be exceeded, and a height-compensating element with a height to be determined iteratively must always be inserted for example.

It is clear from the above that the procedure used previously is iterative rather than forward-looking, and therefore is accordingly time-consuming and inefficient.

Hereinbelow, examples of production systems 34 according to the present disclosure and methods carried out by these production systems will be described, with reference to FIGS. 3, 3a, 3b and 4.

One thing that these examples according to the present disclosure have in common is that actual height values of at least the alternately stacked components may be determined, by measuring or by calculating the height values on the basis of measured values. During stacking within the stacking device, these height values are used to individually and flexibly control the stacking process for the purpose of achieving a target height.

FIG. 3 shows a first embodiment of a production system 34, which once again comprises a bipolar plate manufacturing line 36, a cell manufacturing line 38 and a stacking device 40. Height values are determined for the bipolar plates and electrochemical cells produced, which height values are taken into account when subsequently producing a stack from these components by means of the stacking device 40.

In the variant shown in FIG. 3, the height values of each bipolar plate are individually measured and/or calculated and stored. As in the prior art, the bipolar plates are manufactured within the bipolar plate manufacturing line 36 from individual plates that are joined together in pairs. For embossing and/or cutting to size the individual plates in a step S1, suitable tools are used, for example forming or stamping tools. The actual dimensions of the individual plates thus manufactured are determined, for example, when configuring the manufacturing line or at the start of manufacture following a reconfiguration of the manufacturing line.

After each reconfiguration of the manufacturing line, a representative individual plate height value is determined for the individual plates manufactured by said line, without each individual plate being measured separately to determine an individual height value.

Each individual plate has a machine-readable information carrier (for example comprising a serial number or a Data Matrix Code, DMC). This information carrier serves to link the representative individual plate height value (for example indirectly by encoding a memory device link in a code of the information carrier, it being possible for the individual plate height value stored in the memory device to be accessed via the link). Alternatively, the representative individual plate height value is stored directly in the information carrier (for example by encoding the individual plate height value in a code of the information carrier).

It should be noted that at least two different types of individual plates are manufactured, namely individual plates for forming an anode side of a bipolar plate to be produced and individual plates for forming a cathode side of a bipolar plate to be produced. Therefore, at least two type-specific representative individual plate height values are obtained and accordingly stored.

If, within the manufacturing line, the tools for manufacturing at least one of the individual plate types are changed, or if multiple tools for manufacturing at least one of the individual plate types are used in parallel, the individual plate height values may also be determined in a tool-specific manner. The individual plate height values stored overall may therefore be both type-specific and tool-specific.

In addition or as an alternative, there may be batch-specific influences on the individual plate height values, depending on the batch of starting materials used (e.g. a roll of sheet metal). The representative individual plate height values may thus also be determined and stored in a batch-specific manner, for example taking into account a batch-specific sheet thickness. Typically, however, the process of embossing the individual plates has a greater influence on the height values and for example on a variation in the height values. Any change in one of the aforementioned factors may have a significant effect on the individual plate height value, and therefore it is advisable to determine the representative individual plate height value again after every such change, so that said value is then representative until the next such change.

In a step S2, two individual plates are joined to form a bipolar plate. In this connection, the stored representative individual plate height values of the combined individual plates, which may optionally be type-specific, tool-specific and/or batch-specific and/or may depend on the configuration state of the manufacturing line, are automatically read out (for example by optical and/or electromagnetic detection of the information carrier). These individual plate height values are summed to obtain a preliminary height value of the bipolar plate formed and are linked to a machine-readable information carrier that is additionally applied to the bipolar plate.

In a step S3, after the bipolar plate has been coated (for example at least in part in the electrochemically active region), an additional coating height component is added to the preliminary bipolar plate height value and the result is stored as the final bipolar plate height value.

As will be explained below, a final representative bipolar plate height value could also be measured directly.

Additional optional manufacturing steps within the bipolar plate manufacturing line 36 are not shown, but these do not significantly influence the height of a produced stack at the latest subsequent to tensioning. This applies, for example, to a coating of optional bead-type seals of the bipolar plates, for example with an elastomer for the purpose of micro-sealing, which usually completes the production process. Such a coating of the bead-type seals may also be carried out after the illustrated step S3, without the already stored final bipolar plate height values being adjusted again. If no embossed sealing elements are used, the same applies to the placement or application of the sealing elements.

According to the example from FIG. 3, the height values for the electrochemical cells are determined as follows: In the cell manufacturing line 38, in a step S4, membrane electrode assemblies are supplied in the finished state or are manufactured within the manufacturing line. In a step S5, individual gas diffusion layers are cut out or cut off from a material provided for this purpose. Alternatively, in a variant that is not shown, they may also be supplied as ready-cut gas diffusion layers.

In a step S6, in each case one membrane electrode assembly and at least one gas diffusion layer (or two, namely one on each side of the membrane electrode assembly) are joined together to form a cell. The height value of each cell is individually measured and stored, for which purpose the height value is linked to a machine-readable information carrier of each cell.

Manufactured bipolar plates and cells are supplied to the stacking device 40. In a step S7, the stacking device 40, which once again may comprise, for example, an industrial robot, alternately picks up bipolar plates and cells from their respective supply areas. For each component picked up, first the associated height value is determined through machine reading of the information carrier applied thereto. To this end, the component picked up may be held, for example in an automated manner, in the capture area of a camera, a scanner or an electromagnetic detection device. The components picked up are then alternately stacked one on top of the other, with an endplate assembly 22 according to FIG. 1 once again serving as a platform.

In a controller of the stacking device 40, the height values respectively read out are automatically collected and summed. The result of the summing corresponds to an actual height of the stack formed of the components alternately stacked thus far. If the height of the endplate assembly 22 and of the optional unipolar plate 20 is known, the actual total height of the overall stack (including the endplate assembly 22, the unipolar plate 20 and the alternately stacked components) can also be calculated.

Once all the alternately stacked components have been stacked one above the other, the actual height is compared with a target height in a step S8. The target height may refer to the same untensioned state and/or to the same (sub-)stack comprising the alternately stacked components (with or without taking into account the endplate assembly 22), so that comparability is given.

The difference between the calculated actual height and the target height is used to determine the height and/or the number of any height-compensating element(s) that may need to be added, it being possible for said number to be 0, 1, or more than 1. By adding the height-compensating element, the intention is to ensure that the target height is actually achieved.

In a step S9, the second endplate assembly is applied (see endplate assemblies 22 from FIG. 1) as well as optional additional components such as the second unipolar plate 20. The stack thus produced is then finally tensioned.

In contrast to the known variant of FIG. 2, there is no need, and also no intention, to unstack again and iteratively correct the stack composition, for example by subsequently replacing or adding height-compensating element(s). This significantly increases efficiency.

FIG. 3 shows an exemplary combination of first variants for determining the height values of the bipolar plates and electrochemical cells. Further variants for determining these height values will be outlined below. All the variants disclosed for determining the respective height values can be combined with each other at will within a production system 34.

According to a second variant, which is not shown by means of a separate figure, a height value of each finished (e.g. also coated) bipolar plate is measured individually in order to determine height values of the bipolar plates. This may take place within the bipolar plate manufacturing line 36, and for example as an additional final manufacturing step therein. The measured height values are linked, as an individual height value, to a machine-readable information carrier of each coated bipolar plate (e.g. directly encoded therein or indirectly by encoding a link to a memory device in which the height value is stored).

This information carrier is applied to the bipolar plate and comprises, for example, a DMC (Data Matrix Code). In contrast to the variant shown in FIG. 3 and explained above, in this case no individual plate height values or preliminary bipolar plate height values are determined until coating.

Alternatively, according to a third variant, which is likewise not shown by means of a separate figure, the height values of the bipolar plates are determined on the basis of samples. More specifically, in this case a representative bipolar plate height value of a finished (e.g. also coated) bipolar plate is measured on the basis of samples. This representative bipolar plate height value is stored as an applicable bipolar plate height value for a group of finished bipolar plates. This may be useful if sufficiently constant individual plate height values and/or sufficiently constant coating thicknesses within this group can be assumed, for example when being formed in the same tool and without any intervention in the joining and coating processes.

In a manner analogous to the procedure explained above, a representative bipolar plate height value determined on the basis of samples may be applicable, for example, in a type-specific, tool-specific and/or batch-specific manner.

FIG. 3A shows an alternative embodiment of the bipolar plate manufacturing line 36, in which the bipolar plate height values are determined according to yet another variant. In this case, in a step S1a, pre-coated material is used for embossing and cutting individual plates therefrom. Individual plate height values are then determined in a manner analogous to step S1 from FIG. 3, but for the already coated individual plates. In a step S2a, a height value of a bipolar plate assembled from the individual plates is determined, in a manner analogous to step S2 from FIG. 3, but in this case is stored as a final height value.

FIG. 3B shows yet another alternative embodiment of the bipolar plate manufacturing line 36, in which the bipolar plate height values are determined according to yet another variant. In a step S1b, individual plates are embossed, cut to size, and coated. Individual plate height values are then determined in a manner analogous to step S1 from FIG. 3, but in an already coated state. In a step S2b, bipolar plates are assembled from the individual plates, and bipolar plate height values are determined in a manner analogous to step S2 from FIG. 3, but in this case are stored as a final height value.

An alternative variant to FIG. 3 for determining height values within the cell manufacturing line 38 concerns the following: A representative height value may be determined, or more specifically calculated, said representative height value being applicable to a plurality of cells. To this end, representative height values of the gas diffusion layers and membrane electrode assemblies are determined and summed. In the case of the gas diffusion layers, the height value may for example be measured on the basis of samples for each processed material batch and stored for all gas diffusion layers produced from this material batch. A representative height value may also be determined for the membrane electrode assemblies in a manner dependent on the production batch or delivery batch.

Alternatively, a representative height value may be determined on the basis of samples for just one cell component (gas diffusion layer or membrane electrode assembly). For the other cell components, a fixed height value may be assumed if the manufacturing accuracy is sufficient, or the height value may be measured individually.

As an alternative to the aforementioned variants, it is also possible that finished composite elements consisting of an MEA and at least one gas diffusion layer are supplied, which can then be further processed in the same way as composite elements manufactured in the cell manufacturing line 38. For these finished composite elements, in each case an individual height value may be determined, for example, or a representative height value may be determined by means of samples.

Yet another alternative procedure to the example shown in FIG. 3 concerns the use of information carriers in connection with the bipolar plates. Instead of applying one information carrier to each individual plate, it may alternatively be provided that a common information carrier is provided for a group of individual plates. This common information carrier may be linked to an individual plate height value that is applicable to each member of this group. The information carrier may be applied, for example, to a storage device (e.g. a transport box), in which the group of individual plates is delivered to a bipolar plate manufacturing station.

When individual plates from two different groups (e.g. from a group comprising cathode individual plates and a group comprising anode individual plates) are combined to produce a bipolar plate, the representative individual plate height values of these groups are read out and used to determine at least the preliminary bipolar plate height value.

For instance, only the bipolar plate produced is provided with an individually assigned machine-readable information carrier, which is linked to the finally determined bipolar plate height value.

This variant is suitable, for example, if the individual plates are joined to each other in the already coated state, such as by welding or adhesive bonding.

The further exemplary embodiment from FIG. 4 will be described below. The bipolar plate manufacturing line 36 and the cell manufacturing line 38 (including the respective manufacturing sequence thereof) are configured analogous to FIG. 3.

In this example, however, within the stacking device 40, components to be inserted in the stack are selected in a manner dependent on their height value, and components may be paired in a manner dependent on their height value.

More specifically, a large number of components are supplied to the stacking device 40, from which, in principle, multiple stacks can be produced. The stacking device 40 is designed to make selections among this large number of components, after automatically reading out the height values of a plurality of the supplied components in advance, in order to produce therefrom at least portions of a stack that is currently to be produced, see step S7.

This selection may for example be made from the outset in order to form the stack as a whole, or depending on the bipolar plate/cell pair that is currently to be produced, or depending on a defined layer zone that includes a plurality of alternately stacked bipolar plates and cells.

According to a step S8, the stacking device 40 is designed to automatically select the components, taking into account the height values that have been read out, such that a target height of the stack, a target height of a bipolar plate/cell pair, or a target height of an aforementioned layer zone is achieved. To this end, corresponding expected extrapolated target heights can be calculated (for example from height values of components stacked thus far), and components that have suitable height values can be selected in order to bring the expected extrapolated target height closer to a permissible range.

Components that are not selected can be used to produce further stacks or at least one further bipolar plate/cell pair or a further layer zone.

To sum up, in this variant, a choice of components and a stacking order are specified in a forward-looking manner and/or flexibly adjusted on the basis of the height values that are automatically read out.

Once a predefined number of components have been stacked one above the other, the final steps S9 and S10 are once again carried out in a manner analogous to the variant from FIG. 3.

1. A production system for producing at least one electrochemical system that comprises a stack consisting of a plurality of different components which are stacked one above the other along a stacking axis of the stack, with a height dimension of each component extending along the stacking axis, wherein the production system is designed:
a) to determine height values for a large number of components and to store said height values in a machine-readable manner;
b) to automatically read out height values of at least selected ones of the components; and
c) to automatically produce a stack from a number of these components, taking into account the height values read out for these, such that a target height of the stack is achieved.

2. The production system according to claim 1,
wherein the production system is designed to determine the respective height value of at least selected ones of the components individually.

3. The production system according to claim 2,
wherein the individual determination comprises:
individually measuring the height value; and/or
individually calculating the height value as a function of how the component is individually assembled from pre-products.

4. The production system according to claim 1,
wherein the production system is designed to determine, for at least one type of component, a representative height value that is stored for a plurality of components of this type.

5. The production system according to claim 1,
wherein the production system is designed to execute at least one of the following measures in order to store the height values in a machine-readable manner:
saving in an internal memory device of the production system;
saving in an external memory device, the production system being designed to access the external memory device for the purpose of reading out the height values;
encoding a height value in a machine-readable code that is applied to at least one of the components;
encoding a link to a storage location of a height value in a machine-readable code that is applied to at least one of the components.

6. The production system according to claim 1,
wherein at least measures a) and c) are executed in different devices and/or at different manufacturing stations of the production system.

7. The production system according to claim 1,
wherein measure a) is executed for a large number of components, from which multiple stacks can be produced in order to produce a plurality of electrochemical systems.

8. The production system according to claim 1,
wherein the production system is designed to determine a required number of height-compensating elements that are to be arranged in the stack in order to achieve the target height, it being possible for said number to be zero, one, or more than one.

9. The production system according to claim 1,
wherein the production system is designed to determine a required height dimension of at least one height-compensating element that is to be arranged in the stack in order to achieve the target height of the stack.

10. The production system according to claim 1,
wherein the production system is designed to determine a required number of electrochemically inactive dummy cells that are to be arranged in the stack in order to achieve a target height of the stack, it being possible for said number to be zero, one, or more than one.

11. The production system according to claim 8,
wherein the production system is designed to tension the stack only after any height-compensating elements have been arranged in the stack and/or after any dummy cells have been arranged in the stack.

12. The production system according to claim 1,
wherein the production system is designed to select a plurality of components, taking into account the height values thereof, in order to produce the stack. wherein the components are selected in order to produce a common portion of the stack to be produced, such that a target height of said common portion is achieved, and wherein the components are selected by taking into account the actual height value and/or the expected extrapolated height value.

13. The production system according to claim 1,
wherein the production system is designed to determine an actual height value of the at least partially produced stack while the stack is being produced, and/or to determine an expected extrapolated height value of the finished stack.

14. The production system according to claim 13,
wherein the actual height value and/or the expected extrapolated height value is or are determined on the basis of a summing of the height values of the components stacked one above the other thus far.

15. The production system according to claim 1,
wherein the electrochemical system is a fuel cell system and the stack (16, 18) comprises at least one of the following types of components:
bipolar plates formed of two separator plates;
unipolar plates, comprising one or two separator plates at a lowermost or uppermost position in a sub-stack comprising a plurality of alternately stacked bipolar plates and cells;
endplate assemblies;
membrane electrode assemblies (MEA);
seals;
gas diffusion layers;
electrochemical cells, each comprising an MEA and at least one gas diffusion layer.

16. The production system according to claim 1, wherein the electrochemical system is an electrolyzer and the stack comprises at least one of the following types of components:
separator plates between electrochemical cells of the system and/or between an electrochemical cell and an endplate assembly;
endplate assemblies;
proton-exchange membranes;
frame elements;
sealing elements;
gas diffusion layers;
transport layers;
electrochemical cells, each comprising at least one proton-exchange membrane and one or more gas diffusion layers and/or one or more transport layers.

17. The production system according to claim 1, wherein the electrochemical system is an electrochemical compressor or a redox flow battery.

18. The production system according to claim 1,
wherein the stack comprises bipolar plates or single-layer separator plates and/or MEAs and gas diffusion layers as components, the height values of these components referring to at least one of the following states:
height (thickness) of the starting material used to produce the individual plates for producing the bipolar plates;
height after the individual plates have been embossed and/or cut to size to produce the bipolar plates or after the separator plates have been embossed and/or cut to size;
height after the individual plates have been joined to produce the bipolar plates;
height after the bipolar plates or separator plates have been coated;
height after a seal has been applied to the bipolar plates or separator plates
height after the gas diffusion layers have been cut to size;
height of the MEA used;
height after one of the MEAs and one or two gas diffusion layers have been joined, prior to these being arranged in the joined state in the stack to be produced.

19. Method for producing at least one electrochemical system that comprises a stack consisting of a plurality of different components which are stacked one above the other along a stacking axis of the stack, with a height dimension of each component extending along the stacking axis,
wherein the method comprises:
determining height values for a large number of components and storing said height values in a machine-readable manner;
automatically reading out height values of at least selected components; and
automatically producing a stack from a number of these components, taking into account the height values read out for these, namely such that a target height of the stack is achieved.

20. Method according to claim 19,
wherein the stack comprises bipolar plates or single-layer separator plates and/or MEAs and gas diffusion layers as components, the height values of these components referring to at least one of the following states:
height (thickness) of the starting material used to produce the individual plates for producing the bipolar plates;
height after the individual plates have been embossed and/or cut to size to produce the bipolar plates or after the separator plates have been embossed and/or cut to size;
height after the individual plates have been joined to produce the bipolar plates;
height after the bipolar plates or separator plates have been coated;
height after a seal has been applied to the bipolar plates or separator plates
height after the gas diffusion layers have been cut to size;
height of the MEA used;
height after one of the MEAs and one or two gas diffusion layers have been joined, prior to these being arranged in the joined state in the stack to be produced.
